(19) United States
(12) Patent Application Publication
(10) Pub. No.: US 2005/0071296 A1
(43) Pub. Date: Mar. 31, 2005

(54) Commemorative stamps and methods associated therewith

(76) Inventor: Robert Lepkofker, Oceanside, NY (US)

Correspondence Address: ALFRED M. WALKER, 225 OLD COUNTRY ROAD, MELVILLE, NY, 11747-2712, US

(21) Appl. No.: 10/674,685

(22) Filed: Sep. 30, 2003

(51) Int. Cl. G06F 17/60

(52) U.S. Cl. 705/410; 705/411

(57) ABSTRACT

Decorative commemorative stationary materials, such as invitations, envelopes, thank you cards, stamps and commemorative stamps used for legal postage are imprinted with graphic indicia of a person, pet or event being commemorated. In that way, the method of provides a package deal for coordinating a commemorative event with decorative correspondence, such as envelopes, invitations and thank you notes. The commemorative image is imprinted on any documents associated with the commemorative event, as a graphic reminder to the guests of the commemorative event.

### FIELD OF THE INVENTION

The field of the invention is decorative non-commercial commemorative stationary materials, such as invitations, envelopes, thank you cards, stamps and commemorative stamps used for legal postage.

### BACKGROUND OF THE INVENTION

In the prior art, Kaplan (U.S. Pat. No. 5,873,605) teaches a method of incorporating a personal photograph onto a stamp used for legal postage. However, Kaplan requires the photo to be taken at a vending station, which incorporates the photo within a frame of the stamp with the postal value and other legal indicia.

Also in the prior art is Norris (U.S. Pat. No. 6,450,537). Norris teaches a self-service postage stamp assemblage in which a top layer with a transparent window is overlaid onto a personal photograph to provide a legal postage stamp as a composite with the photograph visible through the window while the postage amount and other legal indicia is supplied by the frame area of the top layer.

In either case, the necessary change of postal rules for acceptance of these personalized stamps by the postal service has not been addressed. The form of business organization to support the use of these stamps also has not been addressed.

In addition, Canada Post, the postal service of Canada, provides stamps imprinted with commemorative material for personalizing an occasion with photographic images, artwork, pictures of awards, etc. However, the stamps are official postal rate stamps, not envelopes, invitations, thank you cards and other decorative non-commercial stationary.

Furthermore, it is known to imprint commercial company logos on commercial stationary.

### OBJECTS OF THE INVENTION

It is therefore an object of the present invention to provide a method of providing decorative non-commercial commemorative stationary materials, such as invitations, envelopes, thank you cards, stamps and commemorative stamps used for legal postage.

Ii is also an object to provide commemorative stationary materials associated with a special person or occasion.

Other objects which become apparent from the following description of the present invention.

### SUMMARY OF THE INVENTION

In keeping with these objects and others which may become apparent, the first embodiment of this invention relates to decorative non-commercial commemorative stationary materials, such as envelopes, invitations, thank you cards or stamps which have no legal status as postage stamps. They could adorn an envelope or package in areas not reserved for postal stamps or postage labels or indicia. These personalized stamps are identical in size and overall appearance to ordinary stamps, but lack the country of origin, value and other distinguishing legal indicia. They can be supplied on a backing sheet and can peel off this release liner in a similar fashion to the kiss-cut stamps currently used by the USPS. They can be used to commemorate almost any generally non-offensive person, pet, or event. Small companies as advertising material could also use them. The business structure to support such an endeavor consists of an order-taking entity, which can advertise the service, make customer contact to accept personal material such as photographs and information, and deliver the decorative, non-commercial end product. The other part of the business is a production entity which can interface with the order-taking entity and use equipment to create the form of the commemorative stamp and then create as many copies as ordered by the customer using equipment such as computers, printers, and cutters with stock that will mimic a standard postage stamp. The advertising and customer contact can take many forms. Both print and Internet advertising are possible. The customer contact can be face-to-face through a service distributor who can show decorative, non-commercial samples to a customer and accept customer material and payment. In this case, point-of-sale station displays or wall posters can also be viable advertising media. Alternatively, an 800 number in a magazine ad can provide telephone customer interaction. A natural for Internet advertising follow-up can be E-mail whereby the customer can also attach digital photo material, and a web site can show a catalog of decorative, non-commercial options to the customer.

In another alternative embodiment, decorative, non-commercial invitation or other envelopes are pre-printed with decorative commemorative indicia. They could adorn an envelope or package in areas not reserved for postal stamps or postage labels or indicia. The personalized decorative, non-commercial indicia are pre-printed to commemorate almost any generally non-offensive person, pet, or event. Small companies as advertising material could also use them. The business structure to support such an endeavor also consists of an order-taking entity, which can advertise the service, make customer contact to accept personal material such as photographs and information, and deliver the end product. The other part of the business is a production entity which also can interface with the order-taking entity and use equipment to create the form of the commemorative stamp and then create as many copies as ordered by the customer using equipment such as computers, printers, and cutters with envelope stock. The advertising and customer contact can take many forms. Both print and Internet advertising are possible. The customer contact can be face-to-face through a service distributor who can show samples to a customer and accept customer material and payment. In this case, point-of-sale station displays or wall posters can also be viable advertising media. Alternatively, an 800 number in a magazine ad can provide telephone customer interaction. A natural for Internet advertising follow-up can be E-mail whereby the customer can also attach digital photo material, and a web site can show a catalog of decorative, non-commercial options to the customer.

Another embodiment relates to decorative, non-commercial commemorative stamps, which can be used for legal postage. The stamps can be discrete self-adhesive stamps or can be pre-printed on envelope stock. In order to avoid the problems involved with major changes in postal operations and rules, the commemorative stamp can be part of an almost standard postal label as produced by postal meter machines or their internet computer-generated counterparts. The only deviation from current practice is that labels currently include information on the date and place of mailing; also, there is no notion of a meter owner (postal licensee) making a large number of labels for another party for fixed postage to be used as a stamp substitute. The decorative, non-commercial commemorative custom detail can appear in the area of a package label normally reserved for a company logo or advertising message. Thus for the second embodiment, the only change is in the production entity business function. In this case, however, since the production equipment is so easily obtained and used, it can be common to combine it with the order-taking part of the business venture.

The method of the present invention alternatively provides decorative non-commercial invitations to a commemorative event, such as a wedding, confirmation, bar/bat mitzvah, graduation, coordinates planning and implementation thereof by the steps of:

a) providing decorative, non-commercial envelope making;

b) providing decorative, non-commercial invitation printing;

c) inserting photographic indicia of a person(s), event, and/or object to be commemorated onto said decorative, non-commercial invitation and envelope;

d) providing address information for recipients;

e) mailing the indicia to recipients;

f) correlating responses from said decorative, non-commercial invitations;

g) providing affair-planning procedures including estimating number of guests and food provided therefor;

h) providing square footage and table seating requirements for the commemorative event based upon the responses received from said decorative, non-commercial invitations;

i) providing party favors;

j) providing music or other entertainment;

k) assembling an accounting of gifts received; and

l) providing decorative, non-commercial thank you cards with the aforesaid photographic indicia.

In that way, the method of the present invention provides a package deal for coordinating a commemorative event with decorative non-commercial correspondence, such as envelopes, invitations and thank you notes. The commemorative image is imprinted on any documents associated with the commemorative event, as a graphic reminder to the guests of the commemorative event.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a front view of a decorative commemorative stamp of the method of the present invention;

FIG. 2 is a is a front view of another decorative commemorative stamp of the method of the present invention;

FIG. 3 is a front view of yet another decorative commemorative stamp of the method of the present invention;

FIG. 4 is a front view of an envelope with a pre-printed commemorative image of the method of the present invention;

FIG. 5 is a front view of a decorative commemorative stamp label of the method of the present invention;

FIG. 6 is a flowchart of the general customer fulfillment process; and,

FIG. 7 is a flowchart of a customer fulfillment process handled over the Internet.

### DETAILED DESCRIPTION OF THE PREFERRED EMBODIMENTS

The present invention has broad applications to many technical fields for a variety of articles. For illustrative purposes only, a preferred mode for carrying out the invention is described herein

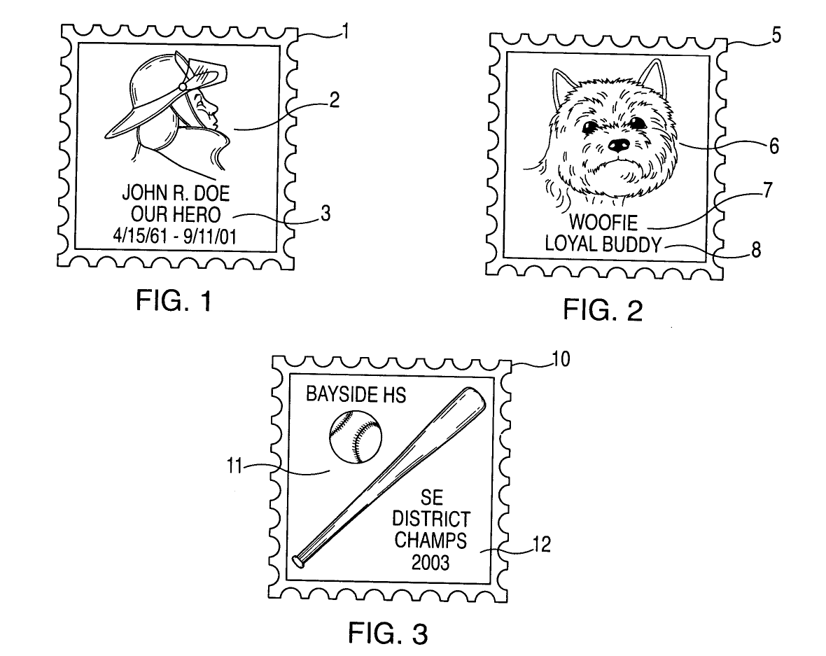

FIGS. 1-3 show decorative commemorative stamps with the typical scalloped edges as produced by kiss-cutting a sheet of adjacent stamps with a special cutter. These stamps can be supplied on a release liner and have pressure sensitive adhesive on their reverse side. It is imperative that the quality of the final product be equal to that of the USPS.

FIG. 1 shows stamp 1 commemorating a deceased person whose picture 2 can be supplied by the customer. The customer can also supply the personal information and commemoration 3. Ample software exists to merge the two customer supplied parts into a cohesive final stamp image. If the photo is supplied as a hard copy, scanning it with a color digital scanner can first digitize it. FIG. 2 shows stamp 5 with a customer-supplied picture 6 and name 7 of a family pet. The commemorative saying 8 can be selected by the customer from a variety of standard sayings, or it can be customized. FIG. 3 shows an example of the commemoration of an event. Stamp 10 with graphic 11 and customer supplied text 12 is used to commemorate a baseball championship. Graphic 11 can be one of a library of standard graphics, or it can be supplied by the customer in concept or finished fashion.

While the images shown in FIGS. 1-3 are depicted as stamps, it is anticipated that commemorative images can be applied to any decorative commemorative non-commercial stationary materials, such as envelopes, invitations, thank you cards or stamps.

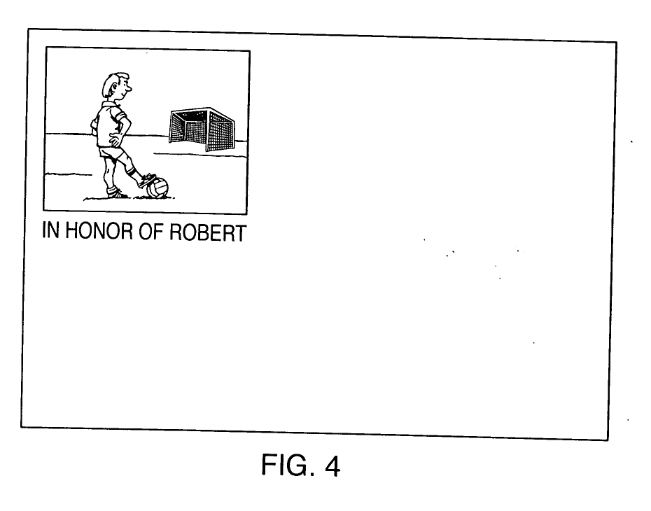

For example, FIG. 4 shows a second embodiment for non-commercial envelope 100 with pre-printed commemorative stamp image 101 printed directly thereon, for example, a picture of a relevant host of an affair, such as a bar or bat mitzvah child or a wedding couple.

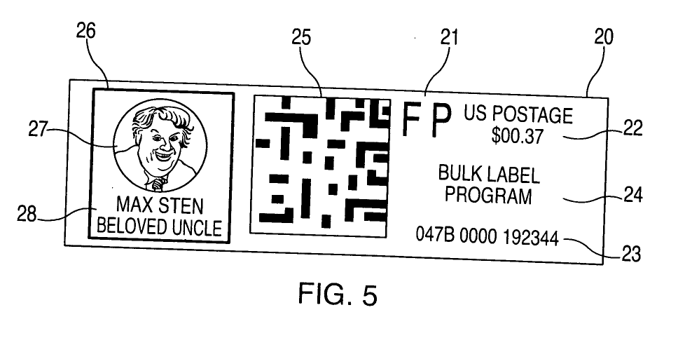

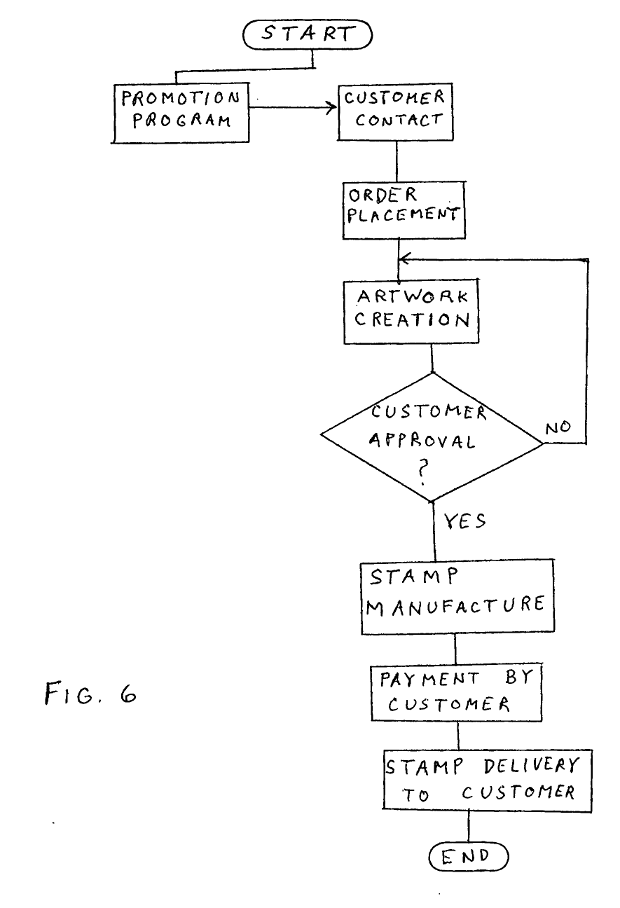

FIG. 5 shows a third embodiment of this invention intended for legal postage use. Label 20 is a standard format package label as produced by postage meters or by standard software for printer use supplied by mailing systems vendors. The example shown in FIG. 5 is a facsimile of a label produced by an FP Mailing Solutions postal meter with the commemorative details of this invention. Pitney Bowes supplies ClickStamp Online (R) software to produce labels on the user's own business computer. It permits the user to select digital picture files with logo or advertising material, which can then be added to the required legal postal indicia. A file substituting the commemorative visual image can be substituted in this case. Each user of this software is licensed by the United States Postal Service (USPS) as if he or she was using a registered postal meter.

For this embodiment, the commemorative information 26 is placed in a label area normally reserved for a company logo or advertising message. The composite of any customer supplied photo image 27 and text 28 must be pre-assembled into a digital file in a computer accessible area for downloading into a postal meter or into postal software system. The other fields of label 20 are statutory by USPS. Two dimensional bar code 25 usually contains the date of mailing, licensing post office, rate category, postage amount and device or meter ID number. This is part of USPS Information-Based Indicia Program and is called an IBI. The mailing system vendor, FP in this example, is identified in 21. The postage amount 22 is printed. The meter number or licensee number is printed at the bottom 23. The area marked Bulk Label Program 24 is special for this commemorative application. This field normally contains the “mailed from” zip code and the “date of mailing” which have no meaning if the labels are being printed in advance of mailing for a third party which may use them in a different zip code area.

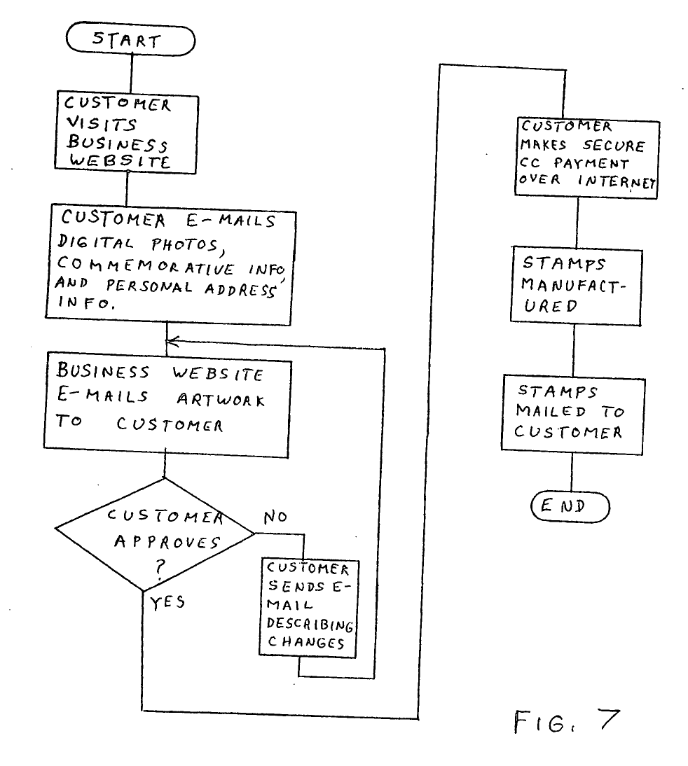

FIG. 6 is a generalized flowchart illustrating the steps in fulfilling a customer order for decorative, non-commercial commemorative stamps. The promotion program initially attracts the customer to place an order. This can be an advertising campaign involving print media, late night TV ads, Internet advertising, point-of-sale posters at a store handling these stamps, or simply word of mouth from a satisfied customer. The order placement likewise can be handled in person, by mail, by phone, or by E-mail. The commemorative information, including photos (if any) are submitted by the customer as part of order placement. From these, artwork for the commemorative stamp is created. The customer is shown an image of the proposed stamp for approval. Changes may be introduced at this point. The stamps can then be manufactured. Payment may be required before or after the actual manufacture.

For example, in a face-to-face situation the stamps would most likely be manufactured prior to payment so that the customer has final approval based on the actual physical stamps. In an Internet situation, credit card payment would be required prior to manufacture to minimize deadbeat losses. In any case, the stamps are then delivered to the customer.

FIG. 7 is a flowchart illustrating the use of the Internet for a purchase of custom decorative, non-commercial commemorative stamps. Based on inducement from a promotional program, the customer visits the business web site. The customer then E-mails digital photo (if any) and all commemorative information along with a personal address for delivery of the stamps or annotated envelopes.

The picture may be of a boy or girl having his or her Bar/Bat Mitzvah. The information may have the date along with the name and any biographical data to be included. From this data, artwork is prepared and E-mailed as a JPEG file or similar digital composite to the customer for his or her approval. Changes, such as an alternative photo or print information, can be made at this point and iterated until final approval is achieved. At this point, the customer makes a secure credit card payment via E-mail. The stamps are then manufactured and mailed or otherwise delivered to the customer.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

1. A method of designing decorative non-commercial envelopes comprising:
choosing a objective;
making a pictorial reproduction of the objective;
storing the reproduction; and
reproducing an image of the objective on an envelope.

2. A method of designing non commercial decorative envelopes:
choosing a family event;
taking a commemorative picture of the event; and
reproducing such an image on envelopes.

3. A method of producing decorative non-commercial envelopes comprising:
taking a digital image;
sending such digital image through the Internet to a recipient;
mass reproducing the digital image on envelopes by the recipient; and
shipping finished envelopes back to a client.

4. A method of producing decorative non-commercial envelopes comprising:
scanning a photographs into a computer; and
printing the photographs onto an envelope.

5. A method of producing decorative non-commercial envelopes comprising:
designing personal artwork; and
reproducing such artwork onto envelopes.

6. A method of producing decorative non-commercial envelopes comprising:
taking children's artwork; and
reproducing such artwork on envelopes.

7. A method of producing decorative non-commercial envelopes comprising:
taking artwork; and
reproducing such artwork onto envelopes.

8. A method of providing decorative non-commercial invitations to a commemorative event, and coordinating planning and implementation thereof comprising the steps of:
providing envelope making;
providing invitation printing;
inserting photographic indicia of a person(s), event, and/or object to be commemorated onto the invitation and envelope;
providing address information for recipients;
mailing the indicia to recipients;
correlating responses from the invitations;
providing affair planning procedures including estimating number of guests and food provided therefor;
providing square footage and table seating requirements for the commemorative event based upon the responses received from the invitations;
providing party favors;
providing music;
assembling an accounting of gifts received; and
providing thank you cards with said aforesaid photographic indicia

9. A method of pre-printing commemorative non-commercial stationary with decorative commemorative indicia comprising the steps of:
accepting personal information relating to a person, pet or event to be commemorated;
using said personal information to format a display which commemorates said person, pet or event; and
preprinting envelopes with said display in areas on said envelopes not reserved for the placement of postage stamps, labels or indicia.

10. The method of claim 9 in which a web address is maintained for receiving said personal information over the Internet.

11. The method of claim 9 in which said personal information is delivered in face-to-face contact.

12. A method of printing envelopes with metered postage and displaying decorative non-commercial commemorative indicia comprising the steps of:
formatting personal information relating to a person, pet or event to be commemorated; and
imprinting the formatted personal information along with metered postage on an envelope.

13. A method of making decorative non-commercial stationary commemorating a person, pet or event comprising the steps of:
accepting personal information relating to the person, pet or event to be commemorated in the form of a digital image, wherein a web address is a system for accepting said personal information and accepting payment over the Internet;
using said personal information to manufacture a number of commemorative stamps displaying said personal information and mimicking the appearance of a standard postage stamp;
confirming a payment by electronic mail;
confirming receipt of said personal information by electronic mail; and
delivering said commemorative stationary.
